(19) United States
(12) Patent Application Publication
(10) Pub. No.: US 2008/0229941 A1
(43) Pub. Date: Sep. 25, 2008

(54) Nano-imprinting apparatus and method

(76) Inventor: Babak Heidari, Furulund (SE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/808,890

(22) Filed: Jun. 13, 2007

Related U.S. Application Data
(60) Provisional application No. 60/907,053, filed on Mar. 19, 2007.

(51) Int. Cl. B31F 1/20

(52) U.S. Cl. 101/23; 101/32

(57) ABSTRACT

An apparatus and a method in connection with the lithography of structures on a micro or nanometer scale. A nano-imprinting apparatus according to an embodiment of the invention comprises two rotatably mounted rollers for transferring a pattern of micro or nanometer size to the substrate to be patterned. A first rotatably mounted roller has a patterned circumferential surface for transferring a pattern from the first rotatably mounted roller to a deformable substrate by contacting the patterned surface with the substrate. A second rotatably mounted roller has a principally smooth circumferential surface which faces the patterned surface of the first rotatably mounted roller. Furthermore, the second rotatably mounted roller is rotatably coupled with the first rotatably mounted roller for synchronized rotation of the first and second rollers. The substrate is movable between the first and second rollers such that, when these rollers rotate with respect to each other, the patterned surface of the first rotatably mounted roller comes into contact with the substrate whereby this pattern is transferred from the patterned surface to the substrate.

### TECHNICAL FIELD OF THE INVENTION

The present invention relates in general to lithography and, more particularly, to an apparatus and a method in connection with the lithography of structures on a micro or nanometer scale. In particular, the invention relates to nano-imprint lithography on large area substrates or objects.

### DESCRIPTION OF RELATED ART

The trend in microelectronics is towards ever smaller dimensions. Commercial components are now manufactured with structures of less than one micrometer in size, but there is a need to go even further down in dimensions, to <100 nm. Research concerning nano-components has raised a demand for a commercially applicable manufacturing technique for components with dimensions of <10 nm.

Some of the most interesting techniques for fabrication of micro and nanometer structures include different types of lithography. One of the most promising techniques for reproducing nanostructures—i.e. structures in the order of 100 nm or smaller—is the nano-imprint lithography (NIL) technology. The nanoimprint lithography (NIL) technology, e.g. as described in U.S. Pat. No. 5,772,905, has set out the basic preconditions for the mass production of structures close to atomic scale, see e.g. Stephen Y. Chou, Peter R. Krauss, Wei Zhang, Lingjie Guo and Lei Zhuang: “Sub-10 nm imprint lithography and application”, J. Vac. Sci. Technol. B, Vol. 15, No. 6, (1997). Several research reports have been presented on the subject, but hitherto the NIL technology has been restricted to nano-imprinting on components with a small total area, typically only a few square centimeters, see e.g. Stephen Y. Chou, Peter R. Krauss and Preston J. Renstorm: “Nanoimprint lithography”, J. Vac. Sci. Technol. B, 14, 4129 <RTI (1996); K. Pfeiffer, G. Bleidiessel, G. Gruetzner, H. Schulz, T. Hoffmann, H.-C. Scheer, C. M. Sotomayor Torres and J. Ahopelto: “Suitability of new polymer materials with adjustable glass temperature for nanoimprinting”, Proceeding of Micro- and Nano-Engineering Conference, (1998); and Leuven. Bo Cut, Wei Wu, Linshu Kong, Xiaoyun Sun and Stephen Y. Chou: “Perpendicular quantized magnetic disks with 45 Gbits on a 4×4 cm2area”, J. Appl. Phys. 85, 5534(1999).

In a prior art nano-imprint lithography process, a substrate to be patterned is covered by a moldable layer. A pattern to be transferred to the substrate is predefined in three dimensions on a stamp or template. The stamp is brought into contact with the moldable layer, and the layer is softened, preferably by heating. The stamp is then moved by means of a vertical movement towards the softened layer such that the stamp is pressed into the softened layer, thereby making an imprint of the stamp pattern in the moldable layer. The layer is cooled down until it hardens to a satisfactory degree followed by detachment and removal of the stamp. Subsequent etching may be employed to replicate the stamp pattern in the substrate. Although this nano-imprinting process may be capable of mass production, it has hitherto been restricted to nano-imprinting on components with a small total area, typically only a few square centimeters.

A different form of nano-imprint lithography technology is commonly known as step and flash imprint lithography. The international patent application WO 02/067055 discloses a system for applying step and flash imprint lithography. Among other things, this document relates to production-scale implementation of a step and flash apparatus, also called a stepper. The template used in such an apparatus has a rigid body of transparent material, typically quartz. The template is supported in the stepper by flexure members, which allow the template to pivot about X and Y axes, which are mutually perpendicular in a plane parallel to the substrate surface to be imprinted. This mechanism also involves a piezo actuator for controlling parallelism and the gap between the template and the substrate. This system is, however, not capable of handling large area substrates in a single imprint step. A step and flash system offered on the marketplace is the IMPRIO 100, provided by Molecular Imprints, Inc., 1807-C West Braker Lane, Austin, Tex. 78758, U.S.A. This system has a template image area of about 25 mm×25 mm. Although this system is capable of bandling substrate wafers of up to 8 inches, the imprint process has to be repeated by lifting the template, moving it sideways, and lowering it to the substrate again, by means of a X-Y translation stage. Thus, this process is relatively time-consuming and, hence, also less optimum for large-scale production purposes. Further, this imprint process suffers from the drawback that continuous structures which are larger than said template size cannot be produced. All in all, this means that production costs may be too high to make this technique interesting for large-scale production of fine structure devices, especially on large area substrates or objects.

### SUMMARY OF THE INVENTION

With the above and the following description in mind, then, an aspect of the present invention is to provide a nano-imprinting apparatus and method, which seek to mitigate, alleviate or eliminate one or more of the above-identified deficiencies in the art and disadvantages singly or in any combination.

A general object of some embodiments of the present invention is to provide a nano-imprinting apparatus and method for improving fabrication of structures comprising three-dimensional features on a micro or nanometer scale. In particular, it is an object of some embodiments of the invention to provide improved nano-imprinting apparatuses and methods for transferring a pattern of such structures to substrates having widths of more than one inch, and even for widths of 8 inches, widths of 12 inches, and larger. In particular, some embodiments of the apparatus and method have been developed for nano-imprinting of structures on substrates, which substrates have large total areas, normally rectangular-shaped areas, which are greater than approximately 7-20 cm². Moreover, some embodiments of the apparatus and method have been developed for nano-imprinting of structures on continuous substrates, which substrates have large total areas, especially significantly large total areas.

According to a first aspect of the invention, a nano-imprinting apparatus comprises:
a first rotatably mounted roller having a patterned circumferential surface for transferring a pattern from the first rotatably mounted roller to a deformable substrate by contacting said patterned surface with said substrate;
a second rotatably mounted roller having a principally smooth circumferential surface which faces the patterned surface of the first rotatably mounted roller, the second rotatably mounted roller being rotatably coupled with the first rotatably mounted roller for synchronized rotation of said rollers; wherein
the substrate is movable between said rollers such that, when said rollers rotate with respect to each other, the patterned surface of the first rotatably mounted roller comes into contact with said substrate whereby said pattern is transferred from the patterned surface to the substrate.

In one embodiment, at least one of the first and the second roller is arranged to apply a pressure against the other roller when said rollers rotate with respect to each other.

In one embodiment, the mentioned pressure is within the range of 1-100 bar positive pressure, preferably within the range of 10-40 bar positive pressure.

In a preferred embodiment, the second rotatably mounted roller comprises a tubular-shaped cavity for a medium having a certain pressure, a wall of said cavity consisting of a membrane of which one side, which faces away from the cavity, forms said principally smooth circumferential surface.

In one embodiment, the nano-imprinting apparatus further comprises means for adjusting the pressure of said medium to a pressure within a range of 1-100 bar positive pressure, preferably within a range of 10-40 bar.

In one embodiment, the membrane is made of a flexible material, preferably a polymer material or a thin metal, even more preferably a plastic, a rubber or a thin metal, the membrane having a thickness of up to 10 mm, preferably up to 3 mm or even more preferably up to 1 mm.

In one embodiment, the medium comprises a gas.

In a preferred embodiment, said medium comprises air.

In one embodiment, the first rotatably mounted roller has a diameter of up to 5 m, preferably up to 2 m, and even more preferably up to 1 m.

In one embodiment, the first rotatably mounted roller has a length of up to 2.5 m, preferably up to 1.5 m, and even more preferably up to 1 m.

In one embodiment, the ratio between the diameter and the length of the first rotatably mounted roller is 1:2.

In one embodiment, the second rotatably mounted roller has a diameter of up to 5 m, preferably up to 2 m, and even more preferably up to 1 m.

In one embodiment, the second rotatably mounted roller has a length of up to 2.5 m, preferably up to 1.5 m, and even more preferably up to 1 m.

In one embodiment, the ratio between the diameter and the length of the second rotatably mounted roller is 1:2.

In a preferred embodiment, the nano-imprinting apparatus further comprises a heating means for heating the substrate, wherein the heating means is positioned to heat the substrate before said substrate moves between said first and second rollers.

In one embodiment, the heating means is a heating chamber positioned such that the substrate is moveable through said heating chamber such that, during operation, heating of the substrate is performed before said substrate moves between said first and second rollers.

In one embodiment, the heating means comprises at least one further rotatably mounted roller with a principally plane circumferential and heated surface positioned such that the substrate is moveable onto said heated surface such that, during operation, heating of the substrate is performed via said heated surface before said substrate moves between said first and second rollers.

In a preferred embodiment, the nano-imprinting apparatus further comprises a cooling means for cooling the substrate, wherein the cooling means is positioned to cool the substrate after said substrate has passed between said first and second rollers.

In one embodiment, the cooling means is a cooling chamber positioned such that the substrate is moveable through said cooling chamber such that, during operation, cooling of the substrate is performed after said substrate has passed between said first and second rollers.

In one embodiment, the cooling means comprises at least one further rotatably mounted roller with a principally plane circumferential and cooling surface positioned such that the substrate is moveable onto said cooling surface such that during operation, cooling of the substrate is performed via said cooling surface after said substrate has moved between said first and second rollers.

In one embodiment, the substrate is a continuous substrate.

In a preferred embodiment, the substrate is a foil or a thin film.

According to another aspect of the invention, a nano-imprinting method is performed by an apparatus having a first rotatably mounted roller with a patterned circumferential surface for transferring a pattern from the first rotatably mounted roller to a deformable substrate by contacting said patterned surface with said substrate, and a second rotatably mounted roller with a principally smooth circumferential surface which faces the patterned surface of the first rotatably mounted roller, the second rotatably mounted roller being rotatably coupled with the first rotatably mounted roller for synchronized rotation of said rollers, wherein the method comprises:
rotating said rollers with respect to each other; and
moving the substrate between said rollers such that, when said rollers rotate with respect to each other, the patterned surface of the first rotatably mounted roller comes into contact with said substrate whereby said pattern is transferred from the patterned surface to the substrate.

In one embodiment, the method further comprises:

applying a pressure against either of or both of said rollers when said rollers rotate with respect to each other.

In one embodiment, the second rotatably mounted roller comprises a tubular-shaped cavity for a medium having a certain pressure, a wall of said cavity consisting of a membrane of which one side, which faces away from the cavity, forms said principally smooth circumferential surface, and the method further comprises the step of:

adjusting the pressure of said medium to a pressure within a range of 1-100 bar positive pressure, preferably within a range of 10-40 bar.

In one embodiment, the medium comprises a gas.

In a preferred embodiment, the medium comprises air.

In one embodiment, the method further comprises:
heating the substrate before said substrate moves between said first and second rollers.

In one embodiment, the method further comprises:
cooling the substrate after said substrate has passed between said first and second rollers.

In one embodiment, the substrate is a continuous substrate.

In a preferred embodiment the substrate is a foil or a thin film.

According to a third aspect there is provided a nano-imprinting apparatus as disclosed in this specification and in the accompanying drawings.

### BRIEF DESCRIPTION OF THE DRAWINGS

Further objects, features and advantages of the invention will appear from the following detailed description of embodiments of the invention, wherein embodiments of the invention will be described in more detail with reference to the accompanying drawings, in which:

FIG. 1 is a cross-sectional side view of a nano-imprinting apparatus in accordance with an embodiment of the invention;

FIG. 2 is different view of the nano-imprinting apparatus shown in FIG. 1;

FIG. 3 is a cross-sectional side view, on a micro or nano-level, illustrating when a first roller, a second roller and a substrate are arranged generally parallel to each other at the moment of a pattern being transferred from a patterned surface of the first roller to the substrate;

FIG. 4 is a cross-sectional side view of a nano-imprinting apparatus in accordance with an embodiment of the invention, where the nano-imprinting apparatus further includes a heating chamber and a cooling chamber;

FIG. 5 is a cross-sectional side view of a nano-imprinting apparatus in accordance with an embodiment of the invention, where the nano-imprinting apparatus further includes heating rollers and cooling rollers;

FIG. 6 is different view of the nano-imprinting apparatus of FIG. 5;

FIG. 7 is a cross-sectional view of an embodiment of the first and second rollers of the nano-imprinting apparatus shown in FIGS. 5 and 6; and

FIGS. 8-10 illustrate different embodiments of a nano-imprinting apparatus.

### DETAILED DESCRIPTION OF EMBODIMENTS

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention relates, in general, to a nano-imprinting apparatus and method for transferring a pattern from a template to a substrate. The present invention is based on a paradigm different from the prior art of nano-imprinting in that the template is in the form of a rotatably mounted roller to be brought into contact with the substrate to be patterned. Unlike current nano-imprinting apparatuses, some embodiments of the present invention are based on the utilization of two rotatably mounted rollers for transferring a pattern of micro or nanometer size to the substrate to be patterned.

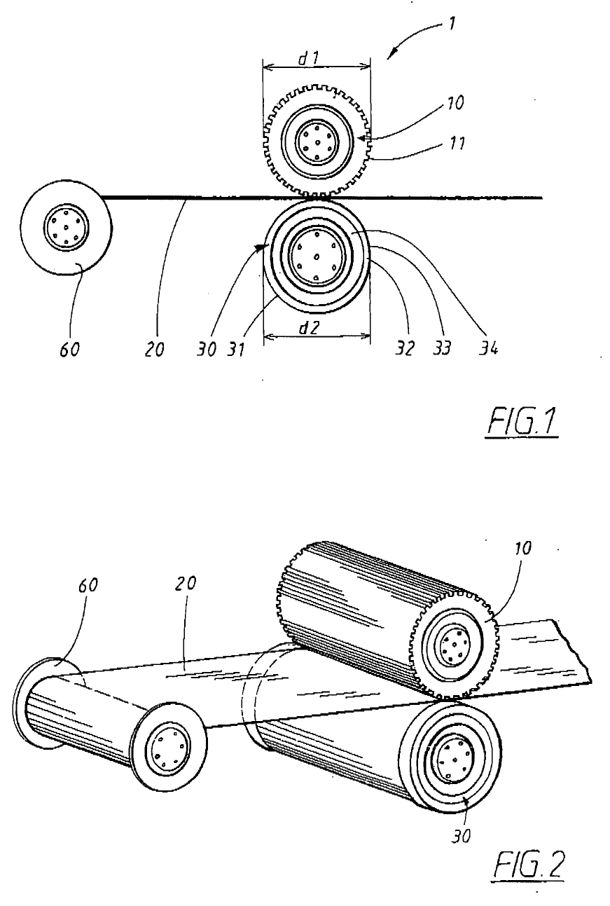

FIGS. 1 and 2 schematically illustrate an embodiment of a nano-imprinting apparatus 1 according to the present invention. The function and the basic process step of the actual pattern transfer step, or imprint step, of an embodiment of the invention will now be described in connection with the nano-imprinting apparatus shown in FIGS. 1 and 2.

The nano-imprinting apparatus 1 comprises a first rotatably mounted roller 10. The first rotatably mounted roller 10 has a patterned circumferential surface 11, in which three-dimensional protrusions and recesses are formed with a feature size in height and width within a range of 1 nm to several μm, and potentially both smaller and larger. The diameter d1 of the cylindrical roller 10 is typically between 1 decimeter and 5 meters. Preferably, the diameter d1 is within the range of 100-1000 millimeters. Furthermore, the length of the roller is typically between 1 decimeter and 5 meters. Preferably, the length of the roller 10 is within the range of 1-3 meters. Preferably, but not necessarily, the ratio between the diameter and the length of the rotatably roller is approximately 1:2. In a best mode as known to the inventor at the filing date of this application, the diameter d1 may be about 600 millimeters and the length about 1.5 meters.

The nano-imprinting apparatus 1 also comprises a second rotatably mounted roller 30. The second rotatably mounted roller 30 is rotatably coupled with the first rotatably mounted roller 10 such that synchronized rotation of the rollers 10, 30 is enabled. By synchronized rotation is meant that the speed of rotation of the first roller 10 is synchronized with that of the second roller 30. Furthermore, the second roller has a principally smooth circumferential surface 31. The diameter d2 of the second cylindrical roller 30 is typically between 1 decimeter and 5 meters. Preferably, the diameter d2 is within the range of 100-1000 millimeters. Furthermore, the length of the second roller is typically between 1 decimeter and 5 meters. Preferably, the diameter is within the range of 1-3 meters. Preferably, but not necessarily, the ratio between the diameter and length is approximately 1:2. In a best mode as known to the inventor at the filing date of this application, the diameter d2 may be about 600 millimeters and the length about 1.5 meters.

The axes of the respective rollers 10, 30 are positioned generally parallel to each other such that the respective surfaces 11, 31 face each other principally in a parallel fashion. Accordingly, the patterned circumferential surface of the first rotatably mounted roller and the principally smooth circumferential surface of the second rotatably mounted roller, which faces the patterned surface, are arranged such that these surfaces 11, 31 are generally parallel to each other when they are pressed towards each other.

A substrate 20 is moveable between the rollers 10, 30, when the rollers 10, rotate with respect to each other. The substrate 20 is a deformable substrate 20, e.g. a substrate of a deformable material or a substrate covered by a deformable coating. The substrate preferably, but not necessarily, has a rectangular shape. The width of the substrate 20 is preferably chosen to correspond to the length of the respective rollers 10, 30. In the preferred and disclosed embodiment, the substrate is a continuous substrate 20. The continuous substrate 20 may be a thin film or a foil, e.g. a polymer foil. As used herein the term continuous substrate is used to mean a substrate with a length which is comparatively much larger than its width, as illustrated in the figures. The continuous substrate 20 may be fed between the rotatably mounted rollers 10, 30 from a feeding device 60. In the preferred and disclosed embodiment, the feeding device 60 is a reel for housing thin film rolls or foil rolls, e.g. polymer foil rolls.

During operation of the nano-imprinting apparatus 1, upon rotation of the rollers 10, 30 with respect to each other, the substrate 20 moves or passes between said rollers 10, 30 such that, when said rollers 10, 30 rotate with respect to each other, the patterned surface 11 of the first rotatably mounted roller 10 comes into contact with said substrate 20 whereby said pattern is transferred from the patterned surface 11 to the substrate 20. In order to accomplish a uniform imprint of the pattern to the substrate 20, the respective rollers 10,30 may advantageously be pressed towards each other. In other words, the first roller 10 may be pressed against the second roller 30, and vice versa further of or both of the first and the second rollers 10, 30 may be arranged to apply this pressure against the other roller 10, 30. The nano-imprinting apparatus 1 may comprise a means for controlling and regulating the applied pressure. It should preferably, but not necessarily, be possible to control and regulate the pressure either dynamically or statically. Furthermore, it should be possible to adjust the applied pressure at least within a range of 1-100 bar positive pressure. In order to accomplish a sufficiently uniform imprint of the pattern on the substrate 20, the applied pressure should preferably be within the range of 10-40 bar.

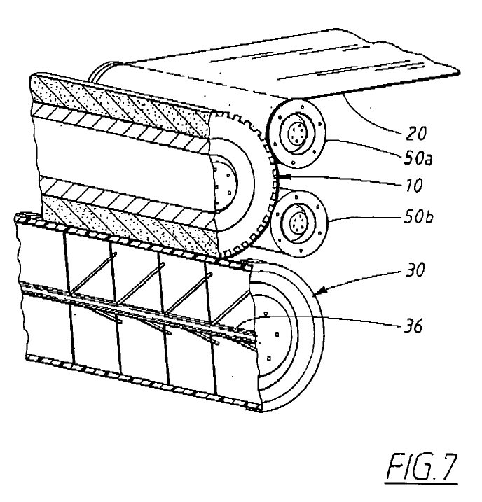

In the preferred and disclosed embodiment, the second rotatably mounted roller 30 comprises a tubular-shaped cavity 32 for a medium having a certain pressure. As is illustrated in the figures, the second roller 30 comprises an inner cylinder 34. A membrane 33 is fit onto the inner cylinder 34 such that the membrane 33 is arranged around the circumferential surface of the inner cylinder 34. Accordingly, the geometric rotational axis of the tubular-shaped membrane 33 can be said to coincide with the rotational axis of the inner cylinder 34. The membrane 33 is typically made of a flexible material. Preferably, the material is a polymer material or a thin metal, even more preferably a plastic or a rubber. In the preferred and disclosed embodiment, the membrane 33 has a thickness of about 1 mm. However, other dimensions are equally possible. As a best mode to the inventor as of the filing date of this application, the thickness of the membrane should be in the range of 1-10 mm. The membrane may be attached to the inner cylinder 34 in many conventionally known manners. As a mere example, the membrane 33 may be clamped to the inner cylinder 34 by clamp means 35 at the respective end sides of the second roller 30. The clamp means 35 is best shown in FIG. 7.

The cavity 32 is intended to accommodate a medium, preferably a gas (e.g. air, nitrogen or argon) which can be pressurized via an inlet channel. The inlet channel may be an inlet channel 36 as illustrated in FIG. 7. Thus, when the space between the inner cylinder 34 and the membrane 33 is filled by the medium, the tubular-shaped cavity 32 is formed. The actual dimension of the space between the inner cylinder 34 and the membrane 33 need not be large. Rather, it is sufficient that this space is in the order of micrometers such that the cavity 32 is capable of accommodating the medium. Pressurization of the medium accommodated in the cavity 32 may then take place e.g. by dynamic control which is adapted to provide pressure with very small variations. Alternatively, the pressure of the medium accommodated in the cavity 32 may be preset to a pre-defined pressure level. The pressure of the medium in the cavity can be increased/decreased via the inlet channel such that the pressure of said medium is in the range of 1-100 bar, preferably within the range of 10-40 bar. When the pressure of the medium in the cavity 32 is increased, the membrane 33 is arranged to flex out.

Again, during operation of the nano-imprinting apparatus 1, the respective rollers 10, 30 are pressed against each other while the substrate 20 moves there between. At the same time, the pressure of the medium in the cavity 32 can be controlled and/or regulated to increase/decrease. Thus, the total pressure between said rollers 10, 30 may be a combined pressure of i) the pressure applied by the rollers 10, 30 against each other and ii) the pressure applied by means of the pressurized gas accommodated in the cavity 32. When the pressure of the medium in the cavity 32 is increased, the membrane 33 flexes out such that the membrane 33 presses the substrate 20 towards the patterned surface 11 of the first roller 10. Thanks to the pressure from the cavity 32 via the flexible membrane 33, an even distribution of force is obtained over the whole of the contact surface between the substrate 20 and the patterned surface 11 of the first roller 10 when the membrane 33 is flexed out due to the pressure of the medium. This is made to arrange roller 10, substrate 20, and roller 30 generally parallel in relation to one another when viewed at a micro or nano level, as is illustratively shown in FIG. 3.

FIG. 3 illustrates a cross-section of a portion of the substrate 20, on a micro or nano size level, when the patterned surface 11 of the first rotatably mounted roller 10 comes into contact with the substrate 20. As is illustrated in FIG. 3, the substrate 20 has an upper surface which is arranged substantially or almost parallel to patterned surface 11 of the template, i.e. the first rotatably mounted roller 10, in the moment of contact between the patterned surface 11 and the upper surface of the substrate 20. Furthermore, the membrane 33 (which forms the surface 31 of the second roller 30) is arranged substantially or almost parallel to the lower surface of the substrate 20. This way, the membrane 33 may act as a generally parallel support member for pressing against the lower surface of the substrate 20 during the imprint of the micro or nano size pattern from the patterned surface 11 of the first roller 10 to the upper surface of the substrate 20.

Since the first roller 10, substrate 20, and second roller 30 are sufficiently parallel in relation to one another (on a micro or nano level) the influence of irregularities in the upper surface of the substrate 20 or on the patterned surface 11 of the first roller 10 may be reduced or even eliminated. Furthermore, the pressure from the cavity 32 via the flexible membrane 33 which acts towards the lower surface of the substrate 20 during imprint may allow for a comfortable imprint of the micro or nano size pattern from the patterned surface 11 into the deformable substrate 20. Furthermore, it has turned out that the pressure of the medium of the cavity 32 may allow for flexing out the flexible membrane 33 such that an imprinting step involves only very little or no sliding effect between the respective rollers 10, 30 and the substrate 20. For avoiding any potential sliding effect it may also be important that the respective rollers 10, 30 are rotatably coupled with respective to each other such that synchronized rotation is enabled.

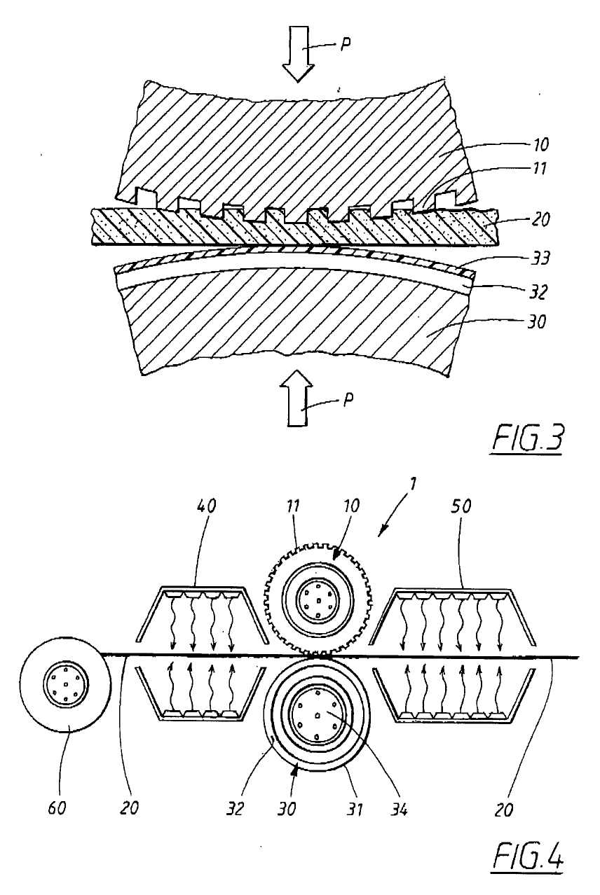

FIGS. 4-6 illustrate various advantageous embodiments of the nano-imprinting apparatus 1 shown in FIGS. 1, 2 and 3, where the nano-imprinting apparatus 1 further includes a heating means 40 and a cooling means 50.

In the embodiment shown in FIG. 4, the heating means 40 is a beating chamber positioned to heat the substrate 20 before said substrate moves between said first and second rollers 10, 30. Accordingly, at least the upper layer of deformable substrate 20 can be softened prior to the subsequent imprinting of the micro or nano size pattern from patterned surface 11 of the first roller 10 to the substrate when said rollers 10, 30 rotate with respect to each other and the patterned surface 11 of the first rotatably mounted roller 10 comes into contact with the substrate 20. Inside heating chamber 40, one or more heaters circulate hot air preferably within the range of 100-200° C., and even more preferably within the range of 150-170° C. Also, the cooling means 50 is a cooling chamber positioned to cool down the substrate 20 after the substrate 20 has passed between said first and second rollers 10, 30 during the imprint step. Accordingly, after the imprinting of the pattern from the patterned surface 11 to the substrate 20, the substrate is cooled down until it hardens to a satisfactory degree. Inside cooling chamber 50, one or more coolers are positioned for lowering the temperature of the substrate 20 so that the substrate is cooled down until it hardens to a satisfactory degree. For cooling down the temperature of the substrate 20, the coolers may be arranged to circulate water or air with a temperature of 130° C. or lower within the cooling chamber 50.

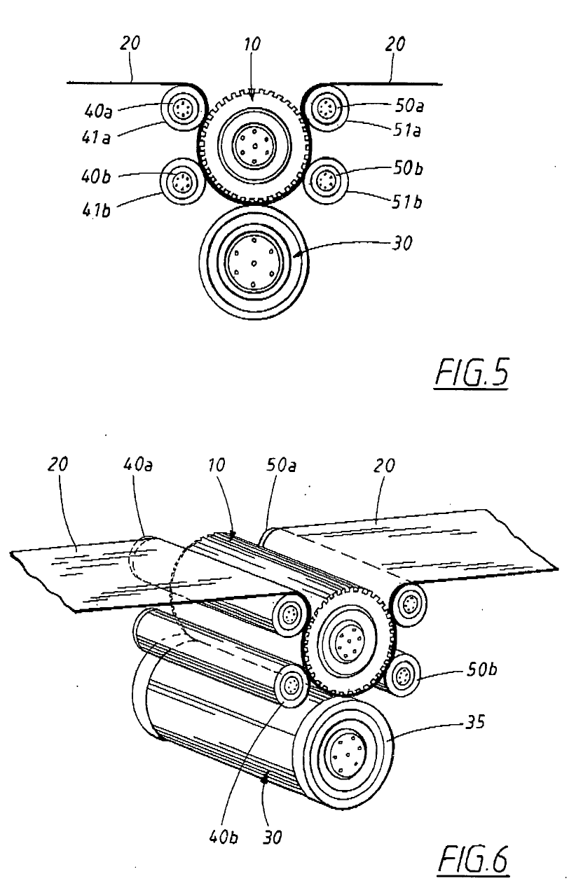

FIGS. 5 and 6 illustrate a preferred embodiment of the invention. In the embodiment shown in FIGS. 5 and 6, the heating means 40 comprises one or more, preferably two, heating rollers positioned to heat the substrate 20. Also, the cooling means 50 comprises one or more, preferably two, cooling rollers positioned to cool down the substrate. In the disclosed and preferred embodiment, two beating rollers 40a, 40b and two cooling rollers 50a, 50b, respectively, are utilized for heating/cooling of the substrate 20.

The nano-imprinting apparatus 1 of FIGS. 5 and 6 comprises two rotatably mounted heating rollers 40a, 40b, each with a principally plane circumferential and heated surface 41a, 41b and means for adjusting a temperature of said surface to a temperature within the range of 100-200° C., preferably within the range of 150-170° C. The heating rollers 40a, 40b are rotatably coupled with the first rotatably mounted roller 10 for synchronized rotation of the heating rollers 40a, 40b and the first roller 10. Consequently, during operation when the heating rollers 40a, 40b and the first and second rollers 10, 30 rotate with respect to each other, the substrate 20 can come into contact with the heated surface 41a, 41b. The heating rollers 40a, 40b may be positioned as illustrated in FIGS. 5 and 6. Hence, during operation, heating of the substrate 20 is performed before said substrate moves between said first and second rollers 10, 30. Moreover, the nano-imprinting apparatus 1 of FIGS. 5 and 6 comprises two rotatably mounted cooling rollers 50, 50b, each with a principally plane circumferential and cooling surface 51a, 51b and means for adjusting a temperature of said surface to a temperature within the range of 130° C. and below. The cooling rollers 50a, 50b are rotatably coupled with the first rotatably mounted roller 10 for synchronized rotation of the cooling rollers 50a, 50b and the first roller 10. Thus, during operation when the cooling rollers 50a, 50b and the first and second rollers 10, 30 rotate with respect to each other, the substrate 20 can come into contact with the cooling surfaces 51a, 51b such that substrate 20 is cooled down until it hardens to a satisfactory degree.

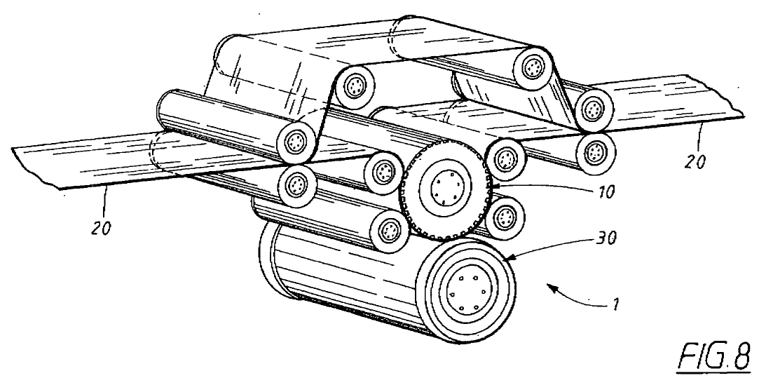

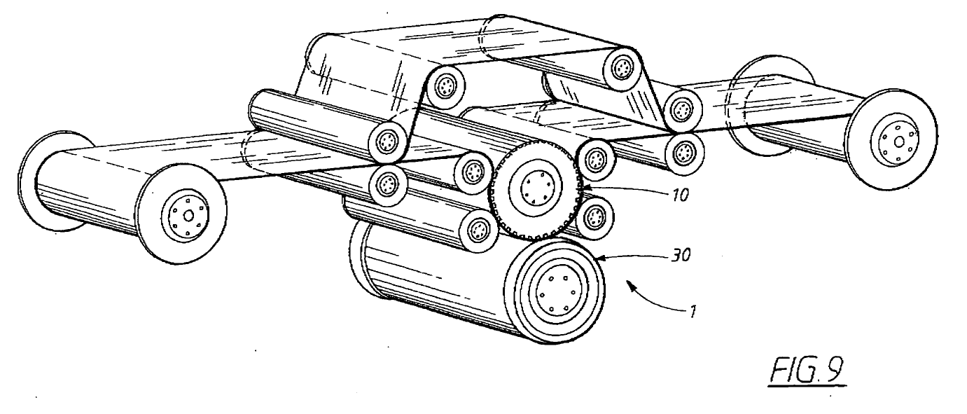

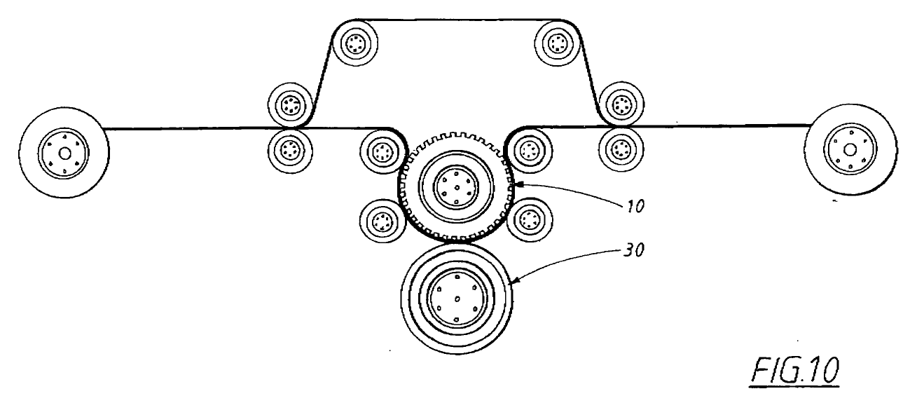

FIGS. 8 to 10 disclose further arrangements or embodiments of a nano-imprinting apparatus 1, which are based on the utilization of rotatably mounted rollers for transferring a pattern of micro or nanometer size to the substrate to be patterned.

Some embodiments of the nano-imprinting apparatus and method according to this invention are particularly advantageous for large area imprint in a single imprint step and have as such huge benefits over previously known techniques for nano-imprint lithography on large area substrates or objects. Thanks to the two rotatably mounted rollers, large area substrates or objects may be in the form of continuous substrates, e.g. thin films or polymer foils, which can move between the two rotatably rollers upon rotation of the rollers. This may allow for a continuous process with high throughput capacity for producing fabrication of structures comprising three-dimensional features on a micro or nanometer scale. Some embodiments of the present invention can be used for transferring a micro or nano size pattern to large-area substrates with total areas of 400×600 mm and larger. For example, full flat panel displays with sizes of about 400×600 mm and larger can thus be patterned with a single imprint in accordance with some embodiments of the invention. Some embodiments of the present invention therefore offers, for the first time, a nano-imprinting apparatus and method which is interesting for large-scale production of fine structure devices on large area substrates or objects, e.g. in applications such as full flat panel displays.

The principles of the present invention have been described in the foregoing by examples of embodiments or modes of operations. However, the invention is not limited to the particular embodiments discussed above, which should be regarded as illustrative rather than restrictive, and it should be appreciated that variations may be made in those embodiments by persons skilled in the art, without departing from the scope of the present invention as defined by the appended claims.

1. A nano-imprinting apparatus, comprising:
a first rotatably mounted roller having a patterned circumferential surface for transferring a pattern from the first rotatably mounted roller to a deformable substrate by contacting said patterned surface with said substrate;
a second rotatably mounted roller having a principally smooth circumferential surface which faces the patterned surface of the first rotatably mounted roller, the second rotatably mounted roller being rotatably coupled with the first rotatably mounted roller for synchronized rotation of said rollers; wherein
the substrate is movable between said rollers such that, when said rollers rotate with respect to each other, the patterned surface of the first rotatably mounted roller comes into contact with said substrate whereby said pattern is transferred from the patterned surface to the substrate.

2. A nano-imprinting apparatus according to claim 1, wherein at least one of the first and the second rollers is arranged to apply a pressure against the other roller when said rollers rotate with respect to each other.

3. A nano-imprinting apparatus according to claim 2, wherein the mentioned pressure is within the range of 1-100 bar positive pressure.

4. A nano-imprinting apparatus according to any one of the claims 1-3, wherein the second rotatably mounted roller comprises a tubular-shaped cavity for a medium having a certain pressure, a wall of said cavity consisting of a membrane of which one side, which faces away from the cavity, forms said principally smooth circumferential surface.

5. A nano-imprinting apparatus according to claim 4, further comprising means for adjusting the pressure of said medium to a pressure within a range of 1-100 bar positive pressure.

6. A nano-imprinting apparatus according to claim 4, wherein the membrane is made of a flexible material, the membrane having a thickness of up to 10 mm.

7. A nano-imprinting apparatus according to claim 4, wherein the medium comprises a gas.

8. A nano-imprinting apparatus according to claim 7, wherein said medium comprises air.

9. A nano-imprinting apparatus according to claim 1, wherein the first rotatably mounted roller has a diameter of up to 5 m.

10. A nano-imprinting apparatus according to claim 9, wherein the first rotatably mounted roller has a length of up to 2.5 m.

11. A nano-imprinting apparatus according to claim 10, wherein the ratio between the diameter and the length of the first rotatably mounted roller is 1:2.

12. A nano-imprinting apparatus according to claim 1, wherein the second rotatably mounted roller has diameter of up to 5 m.

13. A nano-imprinting apparatus according to claim 12, wherein the second rotatably mounted roller has a length of up to 2.5 m.

14. A nano-imprinting apparatus according to claim 13, wherein the ratio between the diameter and the length of the second rotatably mounted roller is 1:2.

15. A nano-imprinting apparatus according to claim 1, further comprising a heating means for heating the substrate, wherein the heating means is positioned to heat the substrate before said substrate moves between said first and second rollers.

16. A nano-imprinting apparatus according to claim 15, wherein the heating means is a heating chamber positioned such that the substrate is moveable through said heating chamber such that, during operation, heating of the substrate is performed before said substrate moves between said first and second rollers.

17. A nano-imprinting apparatus according to claim 15, wherein the heating means comprises at least one further rotatably mounted roller with a principally plane circumferential and heated surface positioned such that the substrate is moveable onto said heated surface such that, during operation, heating of the substrate is performed via said heated surface before said substrate moves between said first and second rollers.

18. A nano-imprinting apparatus according to claim 1, further comprising a cooling means for cooling the substrate, wherein the cooling means is positioned to cool the substrate after said substrate has passed between said first and second rollers.

19. A nano-imprinting apparatus according to claim 18, wherein the cooling means is a cooling chamber positioned such that the substrate is moveable through said cooling chamber such that, during operation, cooling of the substrate is performed after said substrate has passed between said first and second rollers.

20. A nano-imprinting apparatus according to claim 18, wherein the cooling means comprises at least one further rotatably mounted roller with a principally plane circumferential and cooling surface positioned such that the substrate is moveable onto said cooling surface such that, during operation, cooling of the substrate is performed via said cooling surface after said substrate has moved between said first and second rollers.

21. A nano-imprinting apparatus according to claim 1, wherein the substrate is a continuous substrate.

22. A nano-imprinting apparatus according to claim 21, wherein the substrate is a foil or a thin film.

23. A nano-imprinting method performed by an apparatus having a first rotatably mounted roller with a patterned circumferential surface for transferring a pattern from the first rotatably mounted roller to a deformable substrate by contacting said patterned surface with said substrate, and a second rotatably mounted roller with a principally smooth circumferential surface which faces the patterned surface of the first rotatably mounted roller, the second rotatably mounted roller being rotatably coupled with the first rotatably mounted roller for synchronized rotation of said rollers, the method comprising the steps of:
rotating said rollers with respect to each other; and
moving the substrate between said rollers such that, when said rollers rotate with respect to each other, the patterned surface of the first rotatably mounted roller comes into contact with said substrate whereby said pattern is transferred from the patterned surface to the substrate.

24. A nano-imprinting method according to claim 23, further comprising the step of:
applying a pressure against either of or both of said rollers when said rollers rotate with respect to each other.

25. A nano-imprinting method according to claim 23 or 24, wherein the second rotatably mounted roller comprises a tubular-shaped cavity for a medium having a certain pressure, a wall of said cavity consisting of a membrane of which one side, which faces away from the cavity, forms said principally smooth circumferential surface, the method further comprising the step of:
adjusting the pressure of said medium to a pressure within a range of 1-100 bar positive pressure.

26. A nano-imprinting method according to claim 25, wherein the medium comprises a gas.

27. A nano-imprinting method according to claim 26, wherein the medium comprises air.

28. A nano-imprinting method according to claim 23, further comprising the step of:
heating the substrate before said substrate moves between said first and second rollers.

29. A nano-imprinting method according to claim 23, further comprising the step of:
cooling the substrate after said substrate has passed between said first and second rollers.

30. A nano-imprinting method according to claim 23, wherein the substrate is a continuous substrate.

31. A nano-imprinting method according to claim 30, wherein the substrate is a foil or a thin film.

32. (canceled)

33. A nano-imprinting method according to claim 25, wherein the pressure is within a range of 10-40 bar.
